(19) United States
(12) Patent Application Publication
(10) Pub. No.: US 2012/0095740 A1
(43) Pub. Date: Apr. 19, 2012

(54) SIMULATION DEVICE, SIMULATION METHOD, AND RECORDING MEDIUM STORING SIMULATION PROGRAM

(75) Inventors: Eiji KITAGAWA, Kawasaki (JP); Takuro Ikeda, Kawasaki (JP); Hiroshi Yamada, Kobe (JP)

(73) Assignee: FUJITSU LIMITED, Kawasaki (JP)

(21) Appl. No.: 13/337,792

(22) Filed: Dec. 27, 2011

Related U.S. Application Data
(63) Continuation of application No. PCT/JP2009/061970, filed on Jun. 30, 2009.

(51) Int. Cl. G06G 7/48; G06G 7/70

(52) U.S. Cl. 703/6

(57) ABSTRACT

A simulation device is accessible to a recording unit in which simulation data including status data and environmental data is recorded. The simulation device comprises: a plurality of status updaters to refer to the simulation data, and to execute a process of hierarchies into which a status updating process updating the status data is divided, the plurality of status updaters, in accordance with reference range information, referring to simulation data and updating the status data of the movable body for each of the hierarchies; and a drive decision unit to instruct the status updaters to update the status data according to update control information.

### CROSS-REFERENCE TO RELATED APPLICATIONS

This application is a continuation of PCT application PCT/JP2009/061970 which was filed on Jun. 30, 2009, the entire contents of which are incorporated herein by reference.

### FIELD

The embodiments discussed herein are related to the technique of simulating a movable body in the virtual space.

### BACKGROUND

Generally, traffic flow simulators are classified into macrosimulators and microsimulators. The macrosimulators evaluate a wide-ranging traffic situation by handling the traffic flow in analogy to a fluid, and the microsimulators simulate the motion of individual vehicles to reproduce the traffic flow. As the computational complexity is small in macrosimulators, the efficacy of traffic policy across a wide area can be indicated. As an example, the process of assessing the congestion status according to the number and the traveling speed of the vehicles which exist in each of a plurality of images captured by a plurality of capturing devices has been proposed (for example, see Patent Document 1).

### PRIOR ART DOCUMENTS

### Patent Documents

[Patent Document 1] Japanese Laid-open Patent Publication No. 2002-288786

On one hand, the macrosimulators cannot recreate the motion of individual vehicles, and thus it is difficult to evaluate a traffic policy where various driving motions are taken into consideration. On the other hand, the microsimulators can simulate the motion of individual vehicles, but it is difficult to evaluate the traffic policy across a wide area due to the large computational complexity. This problem exists not only in microsimulators which reproduce the traffic flow but also in other simulations in which the motion of individual movable bodies is simulated.

### SUMMARY

A simulation device disclosed in the present application simulates motion of at least one movable body, the simulation device being accessible to a recording unit which records simulation data which includes status data representing a respective status of the movable body and environmental data representing information about a possible factor in changing the status of the movable body, and the simulation device comprising: a plurality of status updaters to refer to the simulation data, and to execute a process of hierarchies into which a status updating process updating the status data according to the referred simulation data is divided, the status updaters, in accordance with reference range information which is preliminarily recorded for each of the hierarchies and which indicates a reference range of the simulation data, referring to simulation data of the reference range and updating the status data of the movable body for each of the hierarchies; and a drive decision unit to instruct the plurality of status updaters having the hierarchies to update the status data, the drive decision unit instructing the plurality of status updaters to update the status data according to update control information in which a timing of updating the status data is defined for each of the status updaters and at a timing defined in the update control information.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a functional block diagram illustrating an example of the configuration of a simulation device according to the first embodiment.

FIG. 2 is a diagram illustrating the contents of road links.

FIG. 3 is a diagram illustrating the contents of vehicle status data.

FIG. 4 is a diagram illustrating examples of the data which defines fields.

FIG. 5 is a diagram illustrating an example of the update control information 5.

FIG. 6 is a diagram illustrating an example of the reference range information 4a-4c.

FIG. 7 is a diagram schematically illustrating the division and hierarchies of the status updating process as an example according to the first embodiment.

FIG. 8 is a diagram schematically illustrating the division and hierarchies of the status updating process as an example according to the first embodiment.

FIG. 9 is an example of a diagram schematically illustrating the status updating process and simulation data range in cases where the status updating process is not divided.

FIG. 10 is a diagram illustrating an example of the amount of the simulation data (upper level) in cases where the status updating process is not divided, and the amount of the simulation data (lower level) in cases where the status updating process is divided such that each of the divided status updating processes has a different cycle.

FIG. 11 is a diagram illustrating an example of the amount of the simulation data (lower level) in cases where the status updating process is divided into hierarchies and localization is further performed so as to decrease the range of the simulation data in the status updating process of a short updating time interval, and the amount of the simulation data (upper level) in cases where the status updating process is not divided.

FIG. 12 is a flowchart illustrating an example of the operation of a simulation device 1.

FIG. 13 is a diagram illustrating an example of the contents of a path link.

FIG. 14 is a diagram illustrating an example of the contents of person status data.

FIG. 15 is a diagram illustrating an example of the contents of product data.

FIG. 16 is a diagram illustrating an example of the update control information according to the second embodiment.

FIG. 17 is a diagram illustrating an example of the reference range information according to the second embodiment.

FIG. 18 is a diagram schematically illustrating an example of the status updating process which is divided into hierarchies according to the second embodiment.

FIG. 19 is a diagram schematically illustrating an example of the status updating process which is divided into hierarchies according to the second embodiment.

FIG. 20 is a flowchart illustrating an example of the operation of a simulation device according to the second embodiment.

FIG. 21 is a functional block diagram illustrating an example of the configuration of a simulation device according to the third embodiment.

### DESCRIPTION OF EMBODIMENTS

Some embodiments of the present invention will be described with respect to the drawings.

### First Embodiment

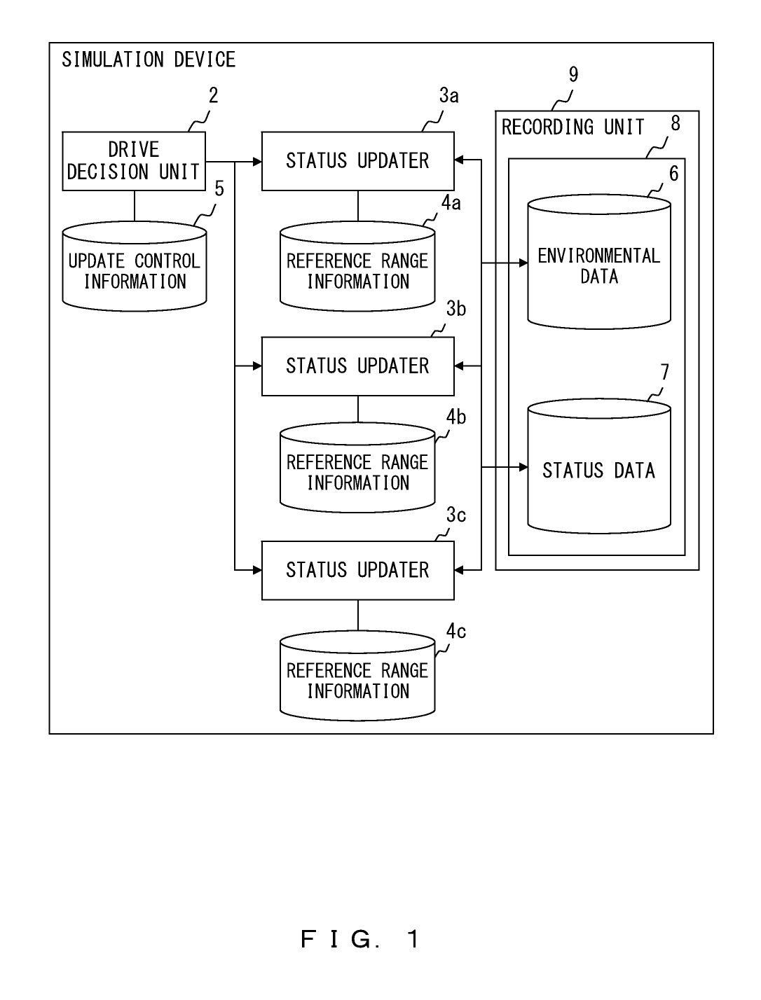

FIG. 1 is a functional block diagram illustrating an example of the configuration of a simulation device according to the first embodiment. A simulation device 1 of FIG. 1 simulates the status changes or drive (motion) of one or a plurality of movable bodies across the area of a specified range. The simulation device 1 includes status updaters 3a-3c which divide originally one status updating process into a plurality of hierarchies and performs a status updating process for each of the hierarchies, and includes a drive decision unit 2 which controls the execution of the status updaters. Moreover, the simulation device 1 is accessible to a recording unit 9, where the recording unit 9 records the simulation data which includes status data 7 representing the status of a movable body and environmental data 6 representing the information on a possible factor in changing the status of the movable body. In the present embodiment, the process is performed in three hierarchies by using three status updaters, but the number of hierarchies is not specifically limited. For example, the number of hierarchies of status updaters, i.e., the number of status updaters 3, is variable depending on the scale of simulation.

Each of the status updaters 3a-3c refers to simulation data 8, and updates the status data 7 of the movable body according to the referred data. The drive decision unit 2 provides instructions to update the status data obtained by each of the status updaters 3a-3c. Each of the status updaters 3a-3c is accessible to reference range information 4a-4c indicating the range of the simulation data referred to in the above-mentioned update. The status updaters 3a-3c refer to the simulation data in the range indicated by the reference range information 4a-4c to update the status data of the movable body.

As described above, the status updaters 3a-3c have a function of selecting a reference range for selecting the simulation data in the range indicated by the reference range information 4a-4c. The reference range information 4a-4c may be recorded in the recording unit 9, but where the reference range information 4a-4c is recorded is not specifically limited. A reference information selecting unit having the reference range information and the above-mentioned function of selecting a reference range may be arranged in the simulation device 1. Moreover, the data configuration of the reference range information may be changed depending on the scale of simulation.

The drive decision unit 2 is accessible to update control information 5 in which the timing of updating each hierarchy of the status updaters 3a-3c and the drive decision unit 2 instructs the status updaters 3a-3c to perform an update at the timing defined in the update control information 5.

According to the configuration of FIG. 1, each of the status updaters 3a-3c is accessible to the reference range information which indicates the range of different simulation data, and the drive decision unit 2 can control the timing of each status updating process (for example, the switching of the status updating process to be executed is controlled) according to the data referred to by each of the status updaters 3a-3c. The simulation by the simulation device 1 is performed as the status updaters 3a-3c refer to the simulation data 8 and repeat updating of the status data 7 according to the referred simulation data. Here, the status updating process is performed by each of the status updaters 3a-3c divided into multiple hierarchies, each of which performs the process of each of the hierarchies. Further, the timing of updating in each of the hierarchies and the range of the simulation data to be referred to are set according to the reference range information 4a-4c or the update control information 5. As described above, the simulation device 1 is configured to divide the status updating process into hierarchies, and to control the timing of updating in each of the hierarchies or the reference range information. Accordingly, it is possible to refer to the simulation data and to perform the status updating processes in an efficient manner. As a result, it is possible to cut down the total amount of data referred to in the status updating processes, thereby enabling large scale simulation.

In the configuration above, it is preferable that the timing of updating each of the status updaters 3a-3c indicated by the update control information 5 is defined according to the range of the simulation data indicated by the reference range information 4a-4c. Accordingly, it is possible to perform the status updating processes at an appropriate timing according to the data referred to in the respective status updating processes.

For example, as will be described later, it is possible to control the status updating processes such that the status updating process of an upper hierarchy refers to the simulation in a wider range and the status updating process of a lower hierarchy refers to the simulation in a narrower range. Further, it is possible to extend the length of execution interval time for the status updating process having a wider reference range of the simulation data. Accordingly, it is possible to reduce the frequency of executing the process in which the amount of the data to be referred to is large and thus a long time and a heavy load are required.

In particular, it is preferable that the update control information 5 include the cycle in which the status updaters 3a-3c refer to the simulation data 8, and for the cycle in which the status updaters 3a-3c refer to the simulation data to become longer as the range of the simulation data indicated by the reference range information 4a-4c becomes wider. Accordingly, it is possible to efficiently reduce the total amount of the simulation data which is referred to in the status updating process performed at constant time intervals (in constant cycles).

The status data 7 is associated with the movable body, and the environmental data 6 is recorded in association with the position information indicating the position at which a factor exists. The range of the simulation data 9 is indicated by an area with reference to the position at which the movable body exists, and the status updaters 3a-3c refer to the status data of the movable body existing in the area and the environmental data of the factor existing in the area. In this case, the range of the simulation data 8 indicated in the reference range information can be represented by an area with reference to the position at which the movable body exists, and the status updaters 3a-3c can refer to the status data of the movable body existing in the area and the environmental data of the factor existing in the area. Accordingly, it is for example possible to achieve localization such that the range of the simulation data in the data referring process of a short cycle becomes spatially small.

The status updaters 3a-3c may change the range of the simulation data 8 indicated in the reference range information 4a-4c by using the timing of updating of each of the status updaters 3a-3c in the update control information 5 or the velocity of the movable body. The velocity of the movable body is included, for example, in the status data 7, and is updated by the status updaters 3a-3c. Accordingly, it is possible to flexibly control the amount of the simulation data in the status updating processes on the basis of the velocity of the movable body and the timing of updating and according to the status of the movable body. For example, the distance of travel for a certain period of time becomes long when the velocity of the movable body is fast, and thus it is possible to perform control such that the range of the simulation data to be referred to will become wider.

By way of example, it is assumed in the simulation device 1 of the present embodiment that the movable body is a vehicle moving on the road. Of the status updaters 3a-3c, the status updater 3a refers to the environmental data 6 which includes the information of the road connection in the first area including the position of the vehicle, and updates at least the route from the current position of the vehicle to the destination. The status updater 3b refers to the status data 7 of the other vehicles in the second area including the position of the vehicle, and updates at least the lane in which the vehicle is traveling. The status updater 3c refers to the status data of the other vehicles in the third area including the position of the vehicle, and updates at least the velocity, direction, and position of the vehicle. The first area, the second area, and the third area may have different sizes in a decremental order.

The simulation device 1 may be realized by installing a specified program to general-purpose computers such as a personal computer or a server machine. Apart from general-purpose computers, the simulation device 10 may be formed, for example, by a computer integrated into electronic equipment such as a vehicle-installed information terminal, a mobile phone, a PDA (Personal Digital Assistant), or an electric home appliance. Alternatively, the function of the simulation device 1 may be distributed over a plurality of computers whereby a plurality of computers configure the simulation device 1.

The functions of the drive decision unit 2 and the status updaters 3a-3c are realized as a processor such as a CPU executes a specified program. In other words, a program for realizing the above-described functions on a computer or a recording medium on which the program is recorded is also an embodiment of the present invention. Moreover, the recording unit 9 and means for recording the update control information 5 and the reference range information 4a-4c are realized by an integrated storage device of a computer or by a storage device accessible by the computer.

Next, the simulation by the simulation device 1 will be described with reference to some specific examples. Here, by way of example, cases will be described in which the simulation device 1 functions as a microsimulator which reproduces the traffic flow by simulating the motion of individual vehicles moving in the virtual space. Here, the motion of a vehicle includes at least one of the behavior of a driver who drives a vehicle (for example, the act of selecting and driving in a non-busy lane depending on a congestion state) and the physical movement of a vehicle body determined by the operations of the driver (for example, a change in the direction of the vehicle body due to steering).

In this case, the environmental data includes the road data of a path through which a vehicle travels in the virtual space. The status data includes the vehicle status data which indicates the status of the vehicle existing in the virtual space. The road data includes, for example, road connection information indicated by nodes and links, map information, traffic signals, facilities, the shape of the road, and the status of a road surface. For example, the nodes indicate intersections, and the links indicate the roads, where unique IDs are assigned to the respective nodes and links. The vehicle status data includes, for example, the vehicle position, the direction of the vehicle, the velocity, and the route to a destination.

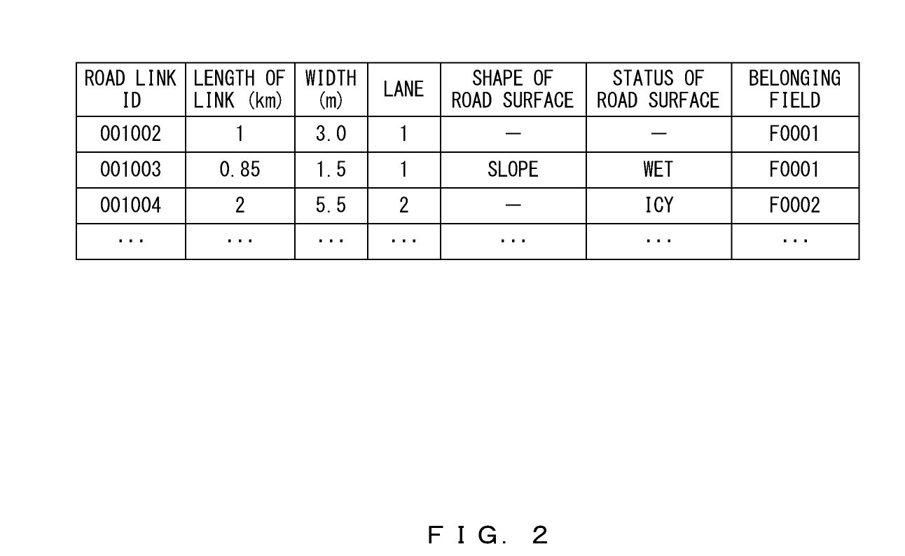

FIG. 2 is a diagram illustrating the contents of road links that are examples of the road connection information included in the environmental data. In the example of FIG. 2, link length, width, the lane, the shape of the road surface, the condition of a road surface, and the assigned field are associated with each road link ID and recorded.

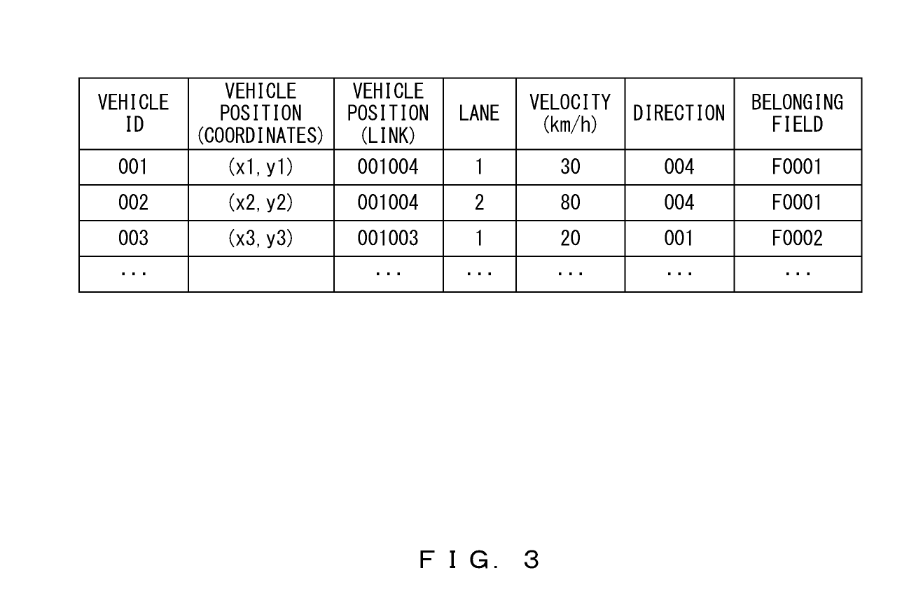

FIG. 3 is a diagram illustrating the contents of vehicle status data. In the example of FIG. 3, a vehicle position (coordinates), a vehicle position (link), a lane, velocity, a direction, and the assigned field are associated with each vehicle ID and recorded. The vehicle position (coordinates) is indicated, for example, by values of latitude and longitude. The vehicle status data of FIG. 3 is referred to and updated when the status updating processes of the status updaters 3a-3b are performed.

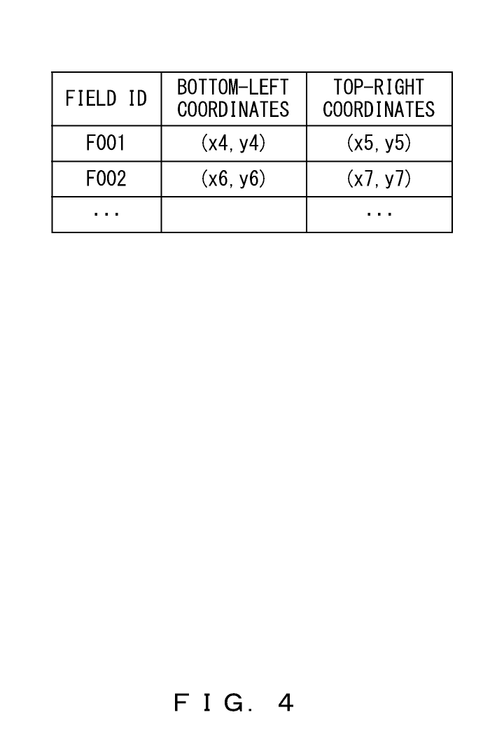

FIG. 4 is a diagram illustrating examples of the data defining the fields, which is an example of the position information indicating the position in the virtual space. Here, the fields are a number of areas obtained by dividing the virtual space to be analyzed. A field is a part of the area in the virtual space. In the example of FIG. 4, a field is a rectangular area, and is indicated by the bottom-left coordinates and top-right coordinates of the rectangular area. Each of the fields has a unique ID. As illustrated in FIGS. 2 and 3, the road link ID, the vehicle ID, and the field ID are associated with each other and recorded. Accordingly, it is possible for the road link and the vehicle status to be associated with the position information and recorded.

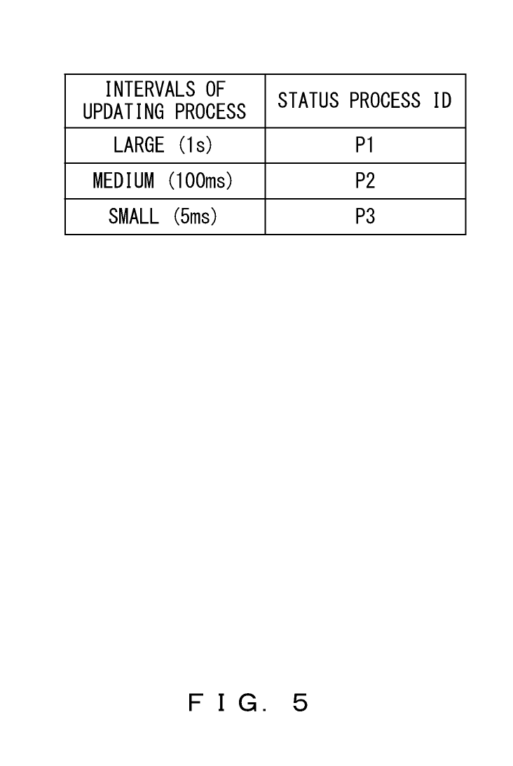

FIG. 5 is a diagram illustrating an example of the update control information 5. In the example of FIG. 5, intervals of the updating process are associated with status update IDs and are recorded. The status update IDs “P1”, “P2”, and “P3” represent the status updating processes by the status updaters 3a-3c, respectively. The interval of the updating process represents a cycle of performing the status updating process (i.e., a cycle of referring to the simulation data). The drive decision unit 2 controls the status updaters 3a-3c according to the update control information of FIG. 5 such that the status updater 3a, the status updater 3b, and status updater 3c execute the status updating process in sequence for every 1 s, 100 ms, and 5 ms, respectively. As described above, the update control information includes the information for identifying each hierarchy of the divided status updating process (or of the status updater), and the information indicative of the timing of execution in each hierarchy. In this example, a longer execution interval time interval is set to a status updater of an upper hierarchy. Accordingly, it is possible to improve the efficiency of the updating process.

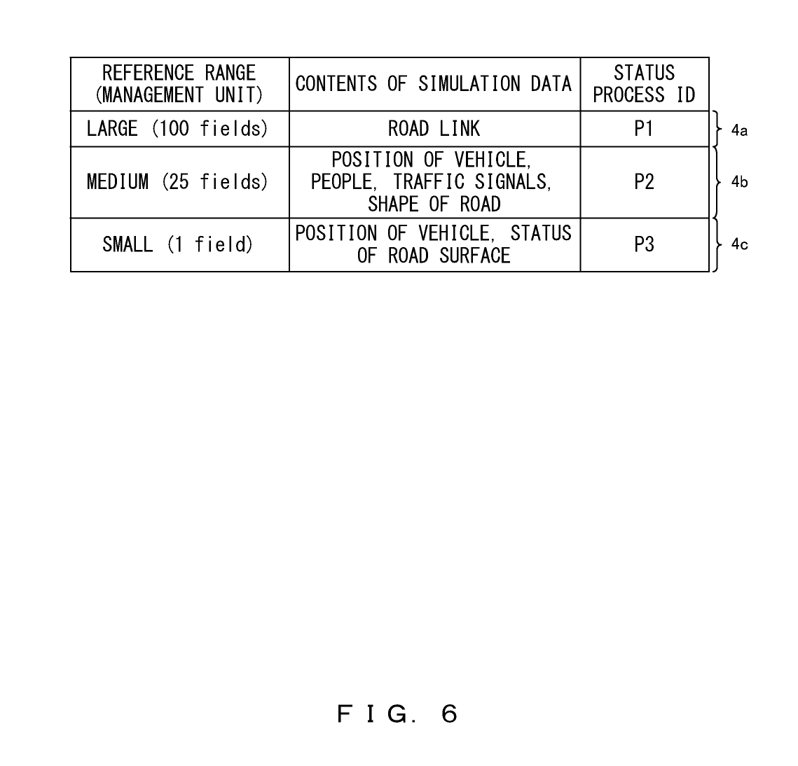

FIG. 6 is a diagram illustrating an example of the reference range information 4a-4c. In the example of FIG. 6, the reference range information 4a-4c is recorded in one table. In the present embodiment, the reference range information is not illustrated within the recording unit, and it is assumed that the reference range information is on a table of the main memory. However, the reference range information may be read from the recording unit. The reference range and the contents of simulation data are recorded for every status processing unit. For example, according to the reference range information 4a, the status updater 3a obtains from the simulation data 8 the road link belonging to 100 fields around the current position of the vehicle in the status updating process P1. The status updater 3b obtains from the simulation data 8 the vehicle information, traffic signals, and the shape of the road belonging to 25 fields around the current position of the vehicle in the status updating process P2. The status updater 3c obtains the vehicle information of the other vehicles in the same field as the current position of the vehicle, and the status of a road surface.

Here, the reference range information 4a-4c has predetermined fixed values, but the reference range information 4a-4c may be variable. For example, the status updaters 3a-3c may create the reference range information 4a-4c indicative of the range of the simulation data 8 by using the cycle of each of the status updaters 3a-3c in the update control information 5 and the velocity of the vehicle. In particular, it is possible that the maximum speed of the vehicle is preliminarily recorded in the status data, and that the size of the reference range is determined according to the maximum speed. When the maximum speed is greater, the size of the area of data to be referred to (here, this is the number of fields) can be larger.

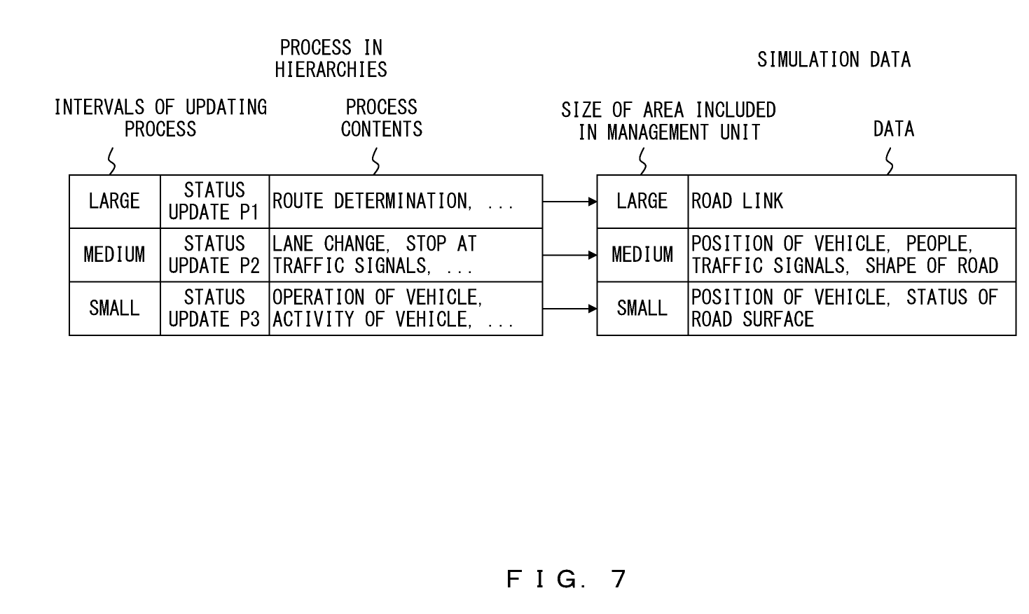

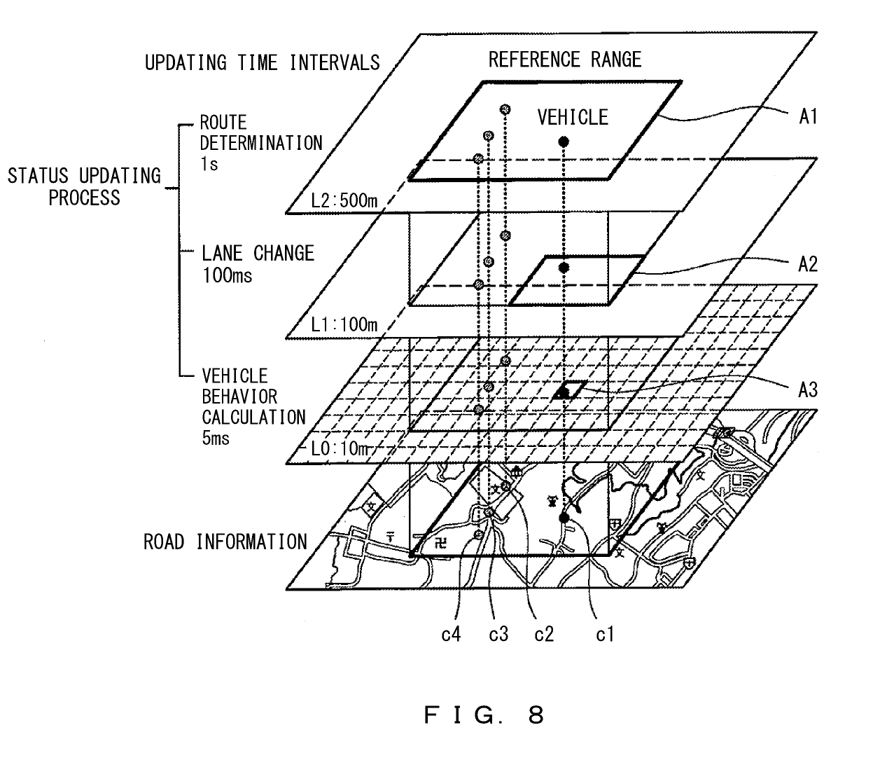

FIGS. 7 and 8 are diagrams schematically illustrating the status updating process which is divided into hierarchies according to the present embodiment. In the present embodiment, as illustrated in FIGS. 7 and 8, the status updating process is divided into three hierarchies. In the three hierarchies, the updating time intervals (cycles) vary in stages in the order of large, medium, and small.

In the status updating process P1 whose hierarchy has a large cycle, the route from the current position of a vehicle to the destination is determined and updated. For this reason, in the status updating process P1, the road link belonging to the 100 fields (management unit A1) which include the current position of the vehicle is obtained from the simulation data 8.

In the status updating process P2 whose hierarchy has a medium cycle, it is determined that there has been a lane change of the vehicle and a stop at a traffic signal, and thereby the lane in which the vehicle is traveling is updated and the existence of a stop is noted. For this reason, the data of the position of the other vehicles, people, traffic signals, and the shape of the road belonging to 25 fields (management unit A2) which include the current position of the vehicle is obtained from the simulation data.

In the status updating process P3 whose hierarchy has a small cycle, the operation of the vehicle and the activity of the vehicle (velocity, direction, position) are updated. For this reason, the data of the position of the other vehicles belonging to the field of the current position of the vehicle (management unit A3) and the status of a road surface are obtained from the simulation data.

The status updating processes P1-P3 are performed for each of the cars c1-c4 in the virtual space. In other words, the status updaters 3a-3c update the status data of each of the cars c1-c4 in the virtual space.

The cycles of updating of the hierarchies vary in stages in the order of large, medium, and small. The data referred to in the hierarchies and the size of the area (the number of fields) included in the reference range (management unit) also vary. As described above, (1) the vehicle status updating process is divided into multiple hierarchies according to the time intervals of the processes, and (2) the simulation data is classified according to the time intervals of being referred to and the simulation data whose referring process time intervals are longer is divided with a large range and is managed. Accordingly, it is possible to reduce the total amount of data referred to in the vehicle status updating process for certain period of time. As a result, it is possible to increase the size by executing the vehicle status updating process at constant time intervals. Note that it is possible to reduce the total amount of data referred to in the process only by executing the process of (1) above. Due to the combination of (1) and (2), it is possible to further reduce the total amount of the simulation data.

The hierarchies of the status updating process of FIGS. 7 and 8 may be determined, for example, according to the decision-making model of humans. As a representative model of human decision making, a three-hierarchy model having the hierarchies of strategy, tactics, and operations may for example be used. As specific examples, a process of determining a route at the level of strategy, a process of selecting a driving mode such as a lane change or a stop at a traffic signal at the level of tactics, and a process of calculating the amount of operation of an accelerator pedal and a brake pedal and thereby physically calculating the activity of the vehicle may be executed by the respective status updaters.

It is not necessary for these processes in the hierarchies to be executed at the same time, and the processes may be executed at unique update intervals. For example, at the level of operational and physical calculation, it is preferable to perform updating at process intervals of several milliseconds so as to control the motion of a vehicle in a sufficiently smooth manner. At the level of tactics, it is necessary and preferable to perform an updating process at process intervals of several hundred milliseconds, as the minimum unit of the cognition and decision-making process of humans is around 100 milliseconds. At the level of strategy, it is preferable to perform an updating process at process intervals of several seconds so as to realize the long-term decision-making process of humans.

As described above, by dividing the status updating process into hierarchies according to the hierarchies of the decision-making model of humans, it is possible to appropriately set the timing of the status updating process according to the level of the decision-making process of a person who is driving the vehicle. For example, due to the hierarchies of the decision-making process, it is possible to perform the process according to the time granularity of the hierarchies. Accordingly, it is also possible to limit the special granularity of the range of collecting the information required for the process. There is another advantageous effect wherein the delayed cognition of humans can be easily simulated.

For example, the process of determining whether a collision with other vehicles has occurred occupies a large proportion of the computational complexity at the level of physical calculation, but even if the speed of an automobile is 200 km/h, the distance that the vehicle travels during the process interval of several milliseconds should be within one meter. Consequently, it is possible to reduce the computational complexity by performing collision determination only for the other vehicles included in the range of one meter around the vehicle.

As another example, the case of turning right at an intersection at the level of tactics will be considered. Whether or not to stop is determined depending on the state of the intersection in front. If the vehicle is traveling at a speed of 100 km/h, the distance that the vehicle travels before it can stop in view of the time taken for a person to realize the danger and start braking hard (about 0.2 second) is calculated as about 100 m. Consequently, the process of determining the possibility of a collision may be performed only for other vehicles in the range calculated as above.

As described above, it is possible to reduce the amount of data to be referred to by dividing the vehicle status updating process into hierarchies and limiting the range of collecting information, thereby reducing the computational complexity in the vehicle status updating process. Moreover, if the hierarchies of human decision making are applied to the hierarchies of the status updating process, it is possible to perform a simulation in which the process of decision making including the delayed cognition of humans is considered. Furthermore, if the vehicle status updating process is divided into multiple hierarchies, it is possible to manage the simulation data at divided sections, and it thus becomes easy to perform the process in a distributed environment by using a number of computing machines.

Hereinafter, the reduction effect in the computational complexity according to the present embodiment will be described.

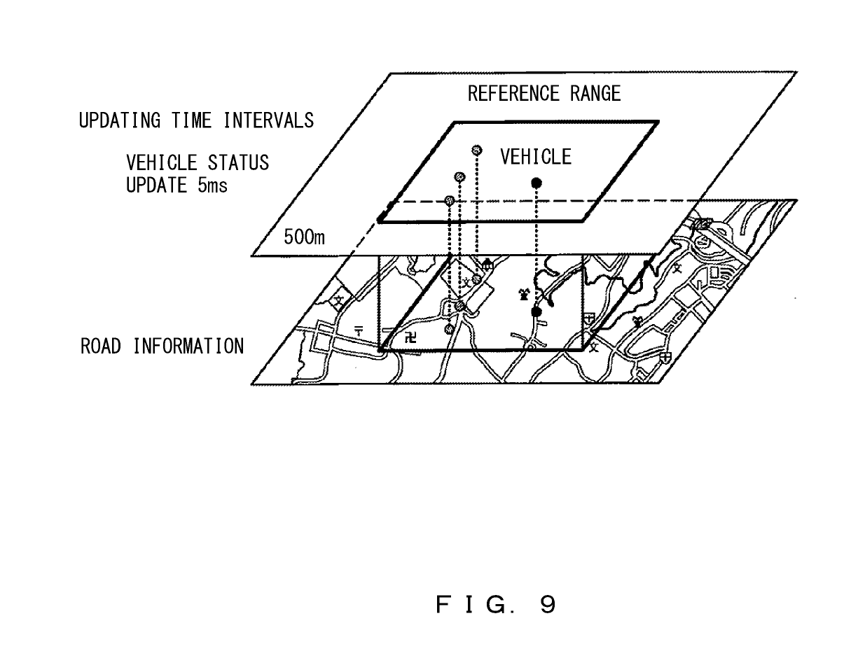

FIG. 9 is a diagram schematically illustrating the status updating process and simulation data range in cases where the status updating process is not divided. In the example of FIG. 9, the cycle of the status updating process is constant (5 ms). Moreover, the management unit is 100 fields. In other words, all the simulation data belonging to the 100 fields is referred to, and the process of updating the status of the vehicle is performed in a cycle of 5 ms.

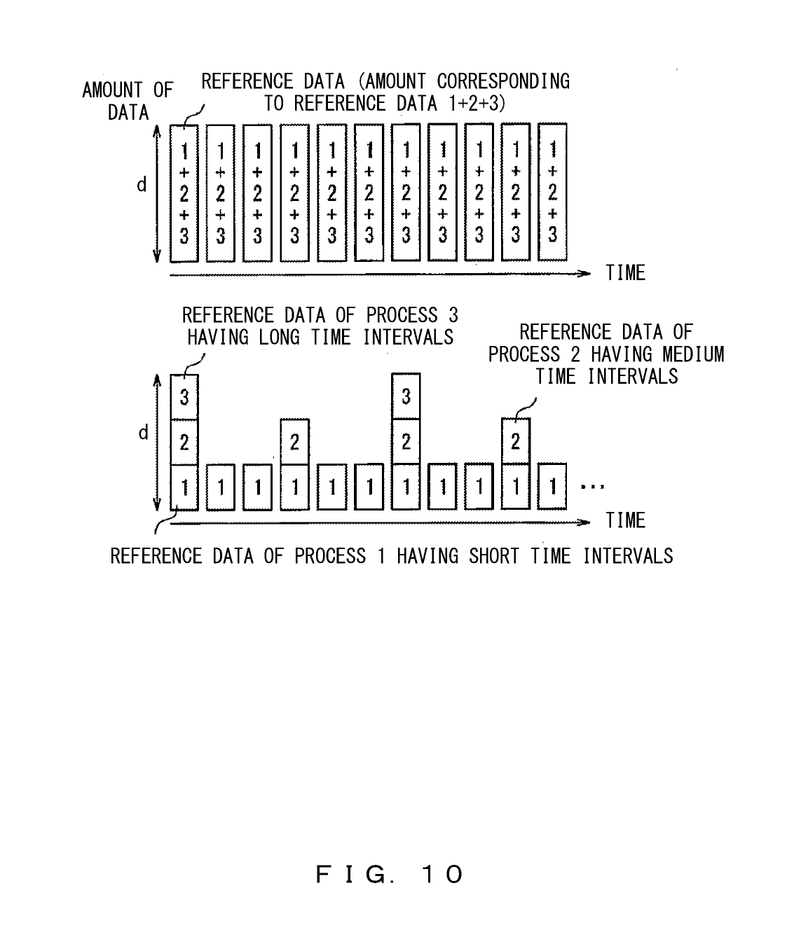

FIG. 10 is a diagram illustrating the amount of the simulation data (upper level) in cases where the status updating process is not divided, and the amount of the simulation data (lower level) in cases where the status updating process is divided such that each of the divided status updating processes has a different cycle, as illustrated in FIG. 9. As illustrated in FIG. 10, all the data is referred to in a single status updating process in the case of FIG. 9. On the other hand, if the process of the status updater is divided into multiple hierarchies according to the process intervals (the cycle of updating), the amount of data referred to in a certain period of time can be reduced. In other words, if the status updating process is not divided, it is necessary to refer to all of the simulation data (1+2+3) every time, which corresponds to the data of three divided hierarchies. If the status updating process is divided, the frequency of being referred to in a certain period of time is reduced for simulation data (3) having long time intervals and simulation data (2) having medium time intervals, relative to the case in which the status updating process is not divided.

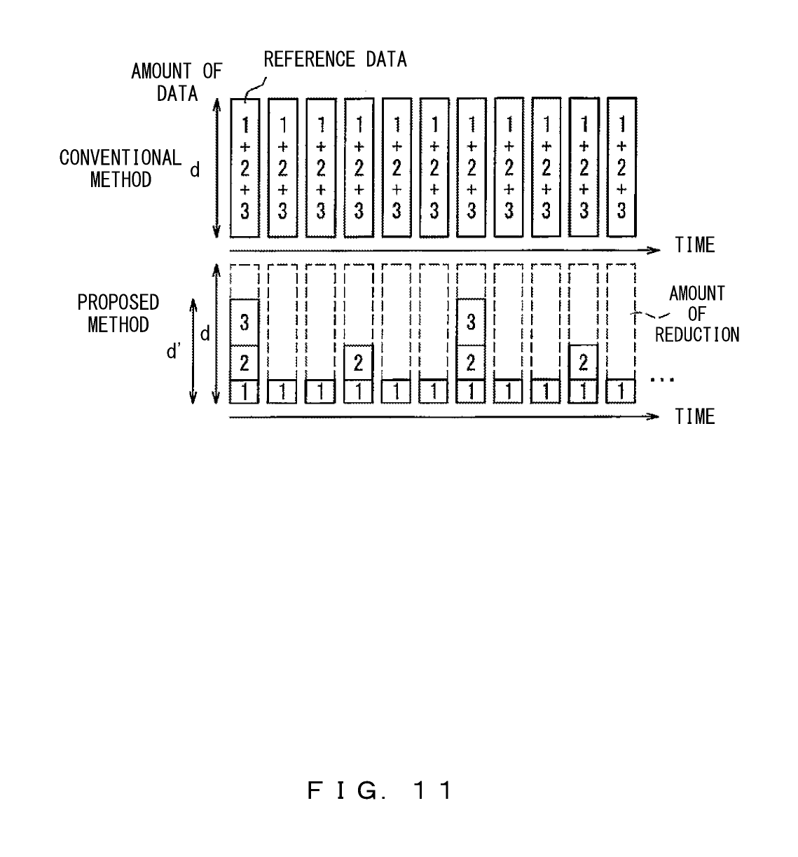

FIG. 11 is a diagram illustrating the amount of the simulation data (lower level) in cases where the status updating process is divided into hierarchies and localization is further performed so as to decrease the range of the simulation data in the status updating process of a short updating time interval, and the amount of the simulation data (upper level) in cases where the status updating process is not divided. The amount of the simulation data illustrated at the lower level of FIG. 11 is an example of the case in which the range of the simulation data is for example set to be smaller for the status updating process having shorter time intervals in the three status updating process hierarchies, as illustrated in FIG. 8. As described above, the total amount of simulation data d′ of the three hierarchies becomes smaller than the one-time amount of the simulation data d of the case in which the status updating process is not divided. Accordingly, it is possible to further reduce the amount of data referred to in a certain period of time.

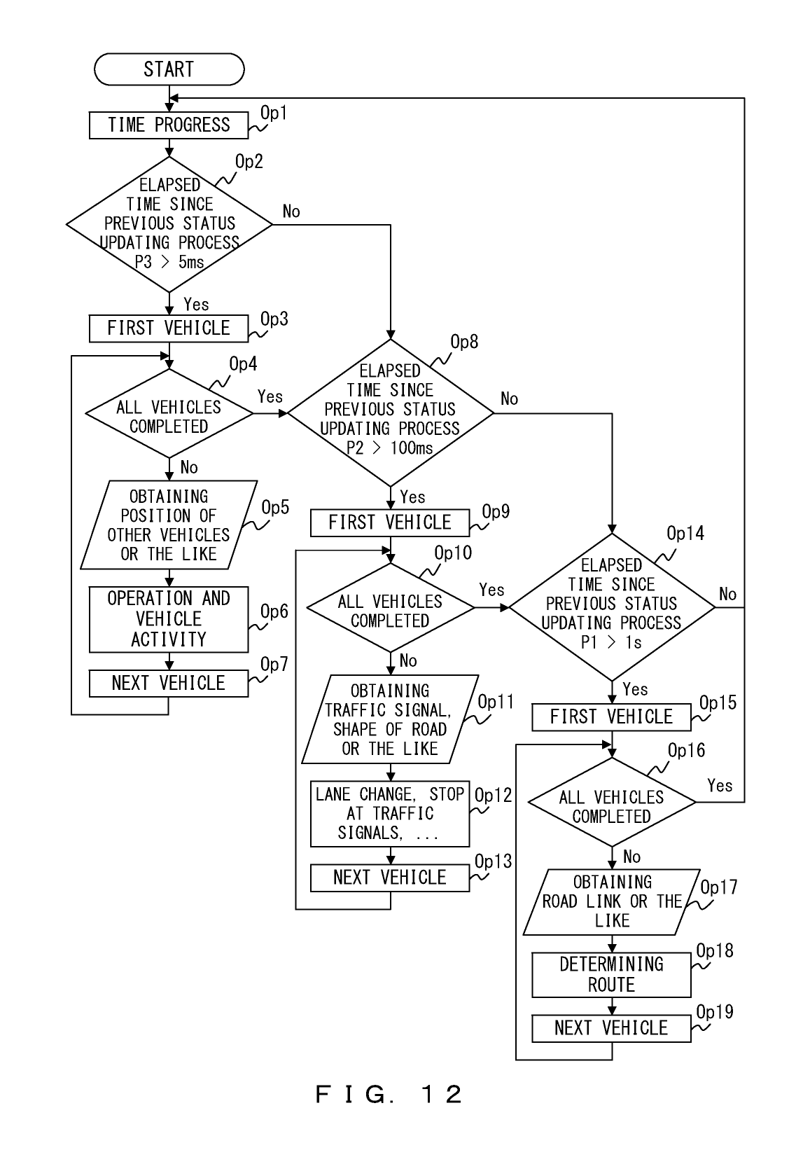

Next, an example of the operation of the simulation device 1 will be described. FIG. 12 is a flowchart illustrating an example of the operation of the simulation device 1. In FIG. 12, the simulation device 1 makes a clock start working when the simulation starts (Op1). Firstly, the drive decision unit 2 instructs the status updater 3a to execute the status updating process P3 when the elapsed time since the previous status updating process P3 executed by the status updater 3c exceeds 5 ms (“Yes” in Op2). When the simulation has just started and the previous status updating processes P1-P3 have not yet been performed by the status updaters 3a-3c, the drive decision unit unconditionally instructs the status updaters 3a-3c to execute the status updating processes P1-P3 in sequence.

When “No” is obtained in Op2, the drive decision unit 2 determines whether the elapsed time since the previous status updating process P2 executed by the status updater 3b exceeds 100 ms (Op8). When it does (“Yes” in Op8), the drive decision unit 2 instructs the status updater 3b to execute the status updating process P2. When “No” is obtained in Op8, the drive decision unit 2 determines whether the elapsed time since the previous status updating process P1 executed by the status updater 3a exceeds is (Op14). When it does (“Yes” in Op14), the drive decision unit 2 instructs the status updater 3a to execute the status updating process P1. Accordingly, the status updating process P3, status updating process P2, and status updating process P1 are executed for every 5 ms, 100 ms, and 1 s, respectively.

When “Yes” is obtained in Op2, the status updater 3c executes the status updating process P3 for all the vehicles in the virtual space (Op3-Op7). In particular, the status updater 3c firstly selects the first vehicle in the virtual space (Op3), and determines whether the status updating process P3 has been completed for all the vehicles (Op4). When it is determined that the status updating process P3 has been completed only for the first vehicle, it is judged that “No” is obtained in Op4. The status updater 3c obtains the data of the position of other vehicles or the like from the simulation data 8 (Op5). At the same time, the status updater 3c obtains the position of other vehicles existing in the field to which the selected vehicle belongs and the status of a road surface in the field in accordance with, for example, the reference range information 4c of FIG. 6. The status updater 3c updates the status data of the selected vehicle by using the obtained data (Op6). Here, by way of example, the operation and the vehicle activity are updated. Once the status data of the selected vehicle is updated, the next vehicle is selected (Op7). The processes of Op5-Op7 are repeated for all the vehicles in the virtual space (repeated until “Yes” is obtained in Op4). With the above, one sequence of the status updating process P3 is completed.

When the status updating process P3 is terminated (when “Yes” is obtained in Op4), the drive decision unit 2 instructs the status updater 3b to execute the status updating process P2. The status updater 3b executes the status updating process P2 for all the vehicles in the virtual space (Op9-Op13). In particular, the status updater 3b firstly selects the first vehicle in the virtual space (Op9), and determines whether the status updating process P2 has been completed for all the vehicles (Op10). When it is determined that the status updating process P2 has been completed only for the first vehicle, it is judged that “No” is obtained in Op10. The status updater 3b obtains the data of the position of other vehicles or the like from the simulation data 8 (Op5). At the same time, the status updater 3b obtains the position of other vehicles existing in the field to which the selected vehicle belongs and the surrounding field (total of 25 fields), the position and status of a person, the status of a traffic signal, and the shape of the road in accordance with, for example, the reference range information 4b of FIG. 6. The status updater 3b updates the status data of the selected vehicle by using the obtained data (Op12). Here, by way of example, a lane change of the selected vehicle and a stop at a traffic signals are determined to exist and updated. Once the status data of the selected vehicle is updated, the next vehicle is selected (Op13). The processes of Op11-Op13 are repeated for all the vehicles in the virtual space (repeated until “Yes” is obtained in Op10).

When the status updating process P2 is terminated (when “Yes” is obtained in Op10), the drive decision unit 2 instructs the status updater 3a to execute the status updating process P3. The status updater 3a executes the status updating process P1 for all the vehicles in the virtual space (Op15-Op19). In particular, the status updater 3a firstly selects the first vehicle in the virtual space (Op15), and determines whether the status updating process P1 has been completed for all the vehicles (Op16). When it is determined that the status updating process P1 has been completed only for the first vehicle, it is judged that “No” is obtained in Op16. The status updater 3a obtains the data of the road link or the like from the simulation data 8 (Op17). At the same time, the status updater 3a obtains the road link existing in the field to which the selected vehicle belongs and the surrounding field (total of 100 fields) in accordance with, for example, the reference range information 4a of FIG. 6. The status updater 3a updates the status data of the selected vehicle by using the obtained data (Op18). Here, by way of example, the route of the vehicle selected by the road link is determined and updated. Once the status data of the selected vehicle is updated, the next vehicle is selected (Op19). The processes of Op17-Op19 are repeated for all the vehicles in the virtual space (repeated until “Yes” is obtained in Op16).

As described above, due to the processes of FIG. 12, it is possible to reduce the total amount of data referred to in the vehicle status updating process of a certain period of time, and to execute the vehicle status updating process at constant time intervals. For example, compared with the case in which all the simulation data (road link, traffic signal, position of other vehicles, or the like) is read at constant time intervals at an individual vehicle and the vehicle status updating process is executed, it becomes possible to reduce the total amount of data referred to in the process. As a result, it is possible to prevent the amount of data referred to in the vehicle status updating process of each vehicle from increasing due to the increase in the number of vehicles or the increase in the target range. Consequently, it becomes easy to increase the scale.

In recent years, traffic policies have been changing with the advance of communications infrastructure or vehicle-installed devices. With dynamic route guidance systems (DRGS), collection of individual information of individual vehicles, or distribution of individual instruction according to individual vehicles will be possible. In order to evaluate such a traffic policy, a microsimulator is required that is of a large scale and has a wide range capable of covering one local district, and that is capable of simulating in detail the diversity of the driving behavior of the drivers of individual vehicles who receive the information. According to the present embodiment, it is possible to provide such a microsimulator.

### Second Embodiment

In the present embodiment, the case will be described in which the simulation device 1 functions as a microsimulator by simulating the motion of individual people moving in the virtual space and by duplicating the flow of people in the facility. The configuration of the device may be the same as that of FIG. 1.

In the present embodiment, the environmental data includes the path data relating to the path on which people move in the virtual space. The status data includes the person status data which indicates the status of people existing in the virtual space (facility such as a store). The path data includes, for example, path connection information indicated by nodes and links, position information, a layout of facilities, information of products on display or exhibits, or the like. Each piece of the person status data includes, for example, the position of people, direction, velocity, route to destination, or the like.

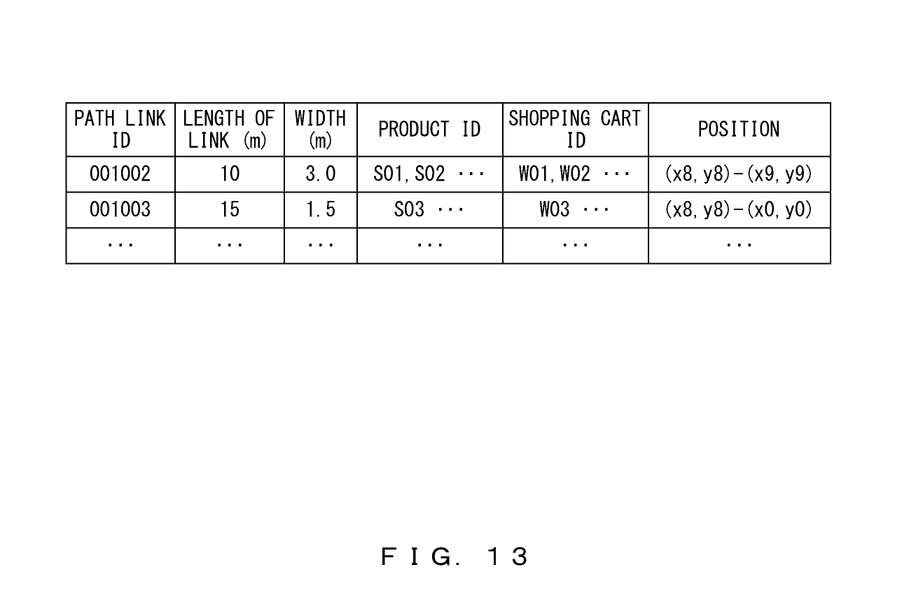

FIG. 13 is a diagram illustrating the contents of a path link as an example of the path connection information included in the environmental data 6 of the present embodiment. In the example of FIG. 13, the link length, width, product ID, shopping cart ID, and position information are associated with each path link ID and recorded.

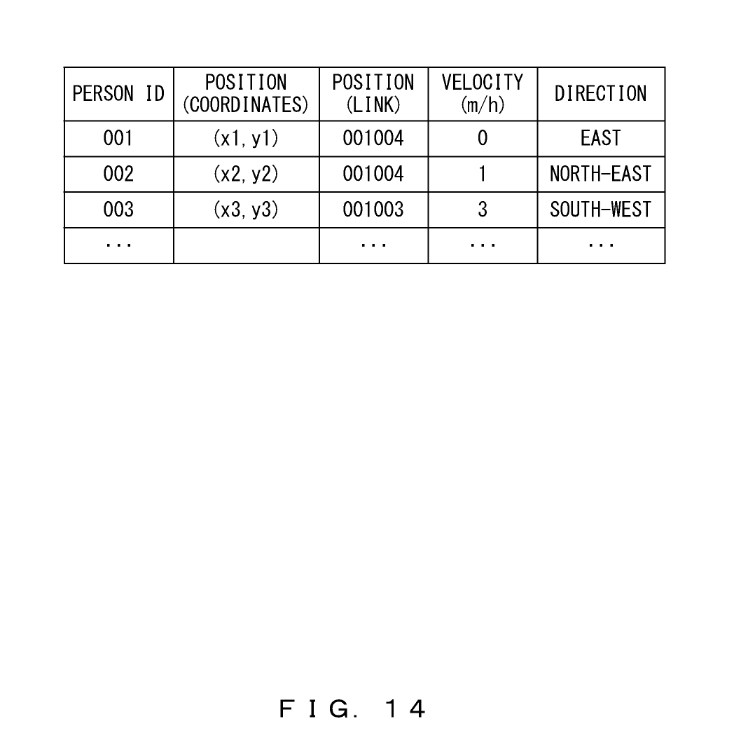

FIG. 14 is a diagram illustrating an example of the contents of the person status data. In the example of FIG. 14, positions (coordinates), positions (links), velocity, and directions are associated with each person ID and recorded. The person status data of FIG. 14 is referred to and updated when the status updating processes of the status updaters 3a-3b are performed.

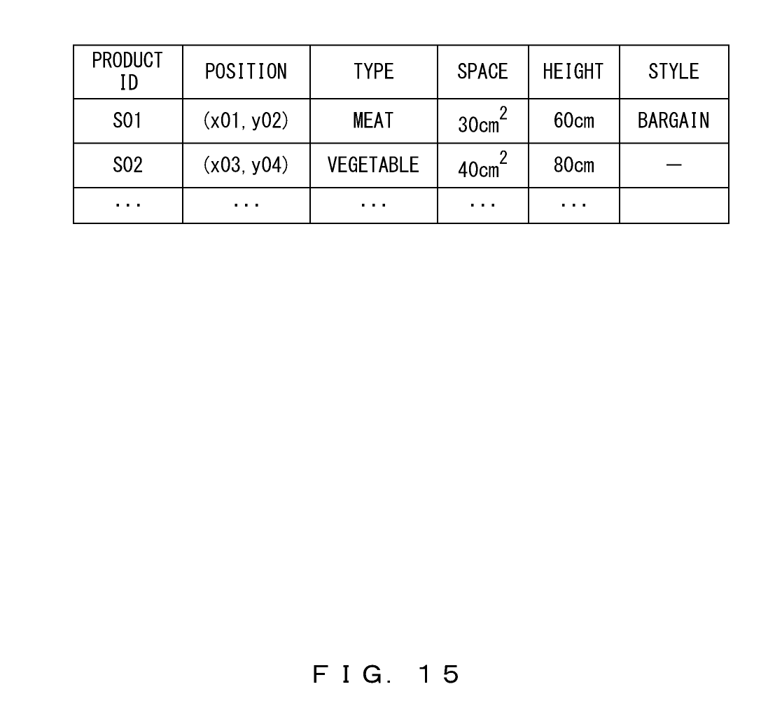

FIG. 15 is a diagram illustrating an example of the contents of product data. In the example of FIG. 15, the position of a display (coordinates), type of product, amount of space, and height are associated with each product ID and recorded.

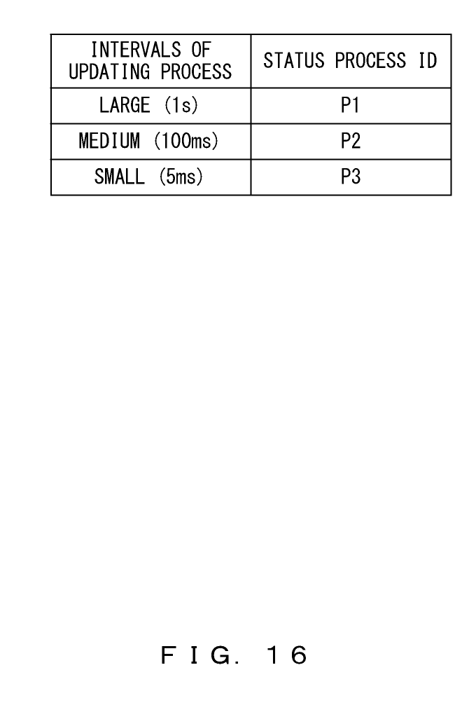

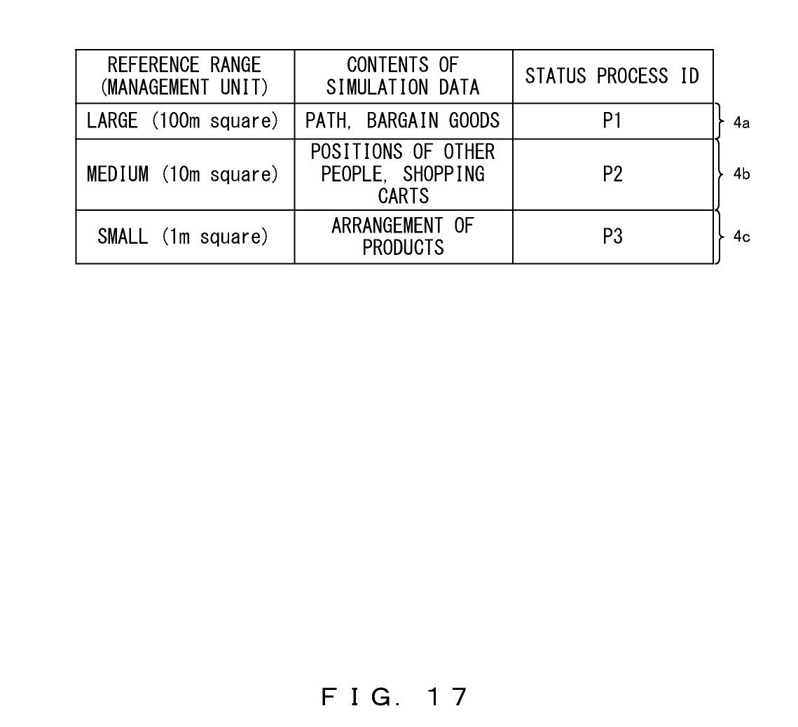

FIG. 16 is a diagram illustrating an example of the update control information 5 according to the present embodiment. FIG. 17 is a diagram illustrating an example of the reference range information 4a-4c according to the present embodiment. For example, according to the reference range information 4a, the status updater 3a obtains from the simulation data 8 the path link and bargain goods belonging to the area within a radius of 100 m around the current position of the person in the status updating process P1. The status updater 3b obtains from the simulation data 8 the positions of other people and shopping carts belonging to the area within a radius of 10 m around the current position in the status updating process P2. The status updater 3c obtains the data indicating the arrangement of products in the area within a radius of 1 m around the current position of the person.

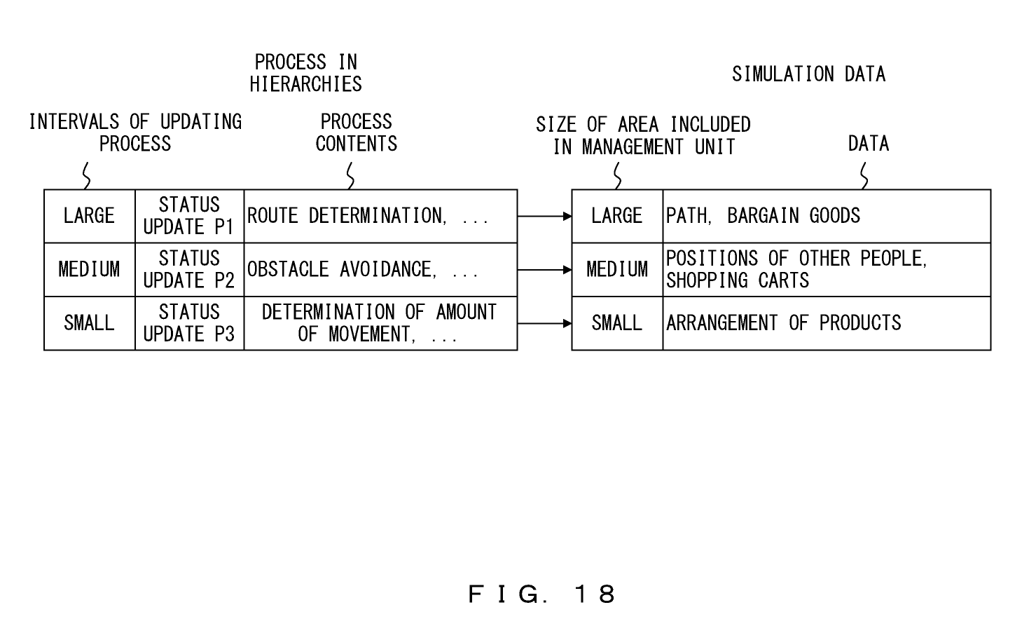

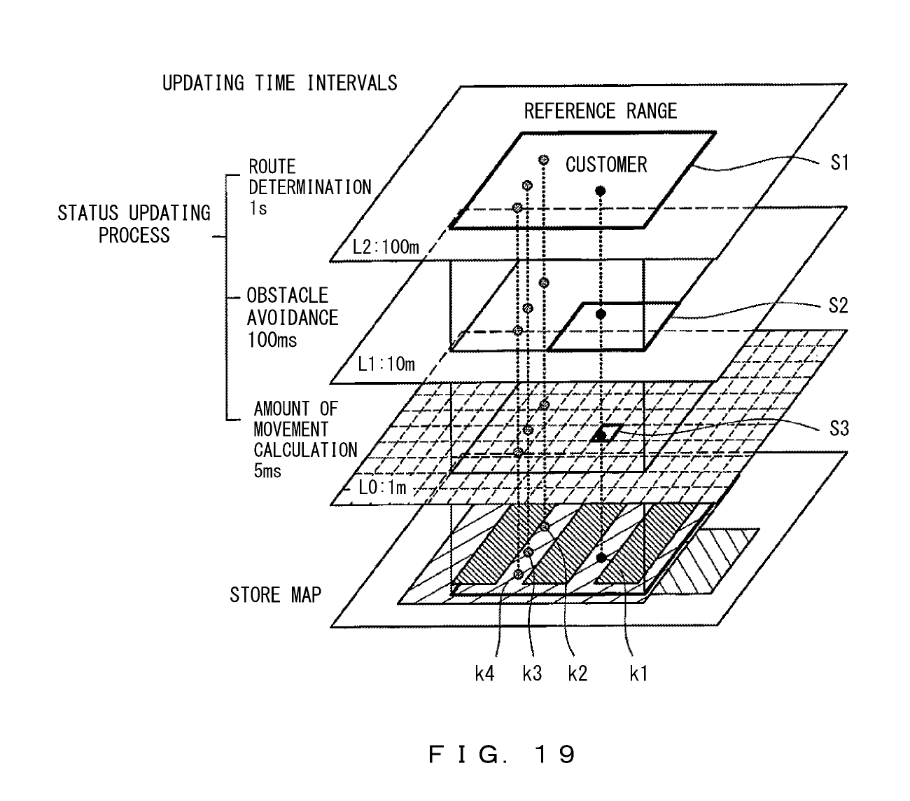

FIGS. 18 and 19 are diagrams schematically illustrating the status updating process which is divided into hierarchies according to the present embodiment. In the present embodiment, as illustrated in FIGS. 18 and 19, the status updating process is divided into three hierarchies. In the three hierarchies, it is assumed that the updating time intervals (cycles) vary in stages in the order of large, medium, and small.

In the status updating process P1 whose hierarchy has a large cycle, the route from the current position of a person to the destination is determined and updated. For this reason, in the status updating process P1, the path link belonging to the area within a radius of 100 m around the current position of the person (management unit S1) is obtained from the simulation data 8.

In the status updating process P2 whose hierarchy has a medium cycle, an obstacle avoidance is determined to exist, thereby updating the direction in which a person is traveling. For this reason, the data indicating the position of obstacles such as other people or shopping carts in the area within a radius of 10 m around the current position of the person (management unit S2) is obtained from the simulation data.

In the status updating process P3 whose hierarchy has a small cycle, the amount of movement by a person is updated. For this reason, the data indicating the arrangement of the products in the area within a radius of 1 m around the current position of the person (management unit S3) is obtained from the simulation data. The status updating processes P1-P3 are performed for each of all the people k1-k4 in the virtual space.

The updating time intervals (cycles) in the status updating process of FIGS. 18 and 19 vary in stages in the order of large, medium, and small. The data referred to in the hierarchies and the size of the area (the number of fields) included in the reference range (management unit) also vary. For this reason, it is possible to reduce the total amount of data referred to in the person status updating process of a certain period of time. Moreover, the process of dividing the information updating process into hierarchies can be determined according to the present embodiment according to the decision-making model of humans. Accordingly, it becomes possible to perform a simulation in which the process of decision making such as the delayed cognition of humans is taken into consideration. According to the present embodiment, it is possible to simulate, for example, the movement of a customer in the store.

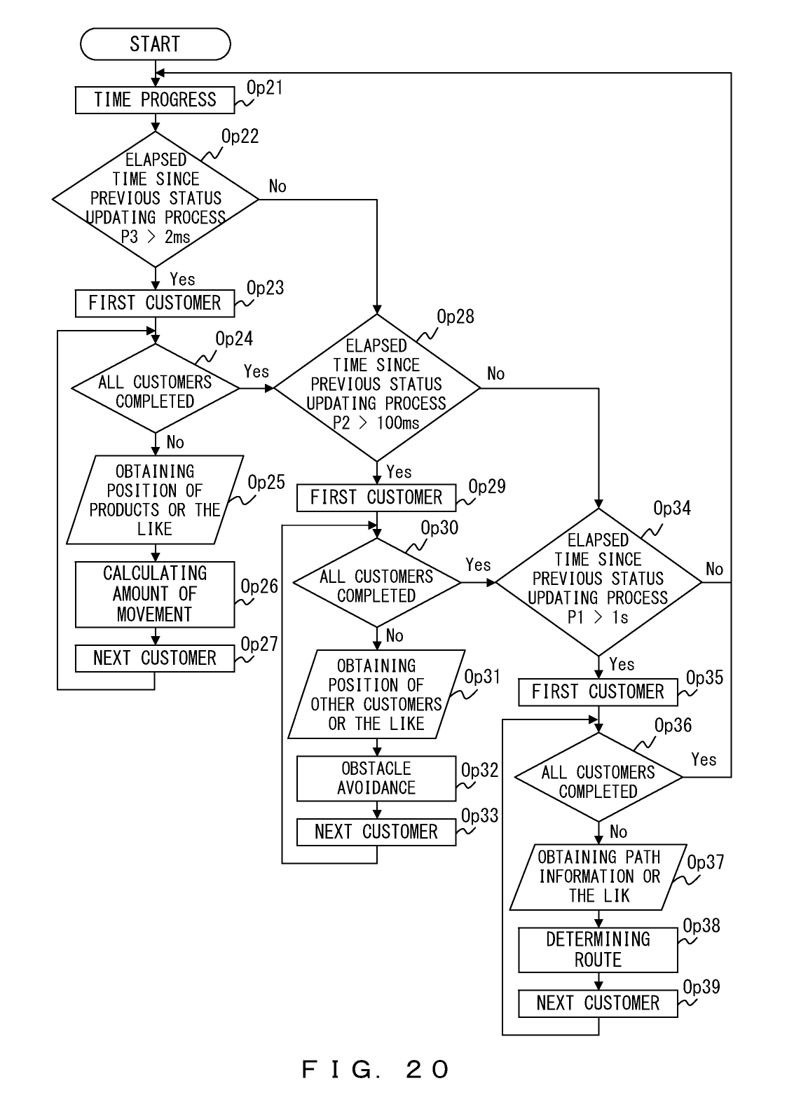

FIG. 20 is a flowchart illustrating an example of the operation of a simulation device according to the present embodiment. In FIG. 20, the simulation device 1 makes a clock start working when the simulation starts (Op21). Firstly, the drive decision unit 2 instructs the status updater 3a to execute the status updating process P3 when the elapsed time since the previous status updating process P3 executed by the status updater 3c exceeds 5 ms (“Yes” in Op22).

When “No” is obtained in Op22, the drive decision unit 2 determines whether the elapsed time since the previous status updating process P2 executed by the status updater 3b exceeds 100 ms (Op28). When it does (“Yes” in Op28), the drive decision unit 2 instructs the status updater 3b to execute the status updating process P2. When “No” is obtained in Op28, the drive decision unit 2 determines whether the elapsed time since the previous status updating process P1 executed by the status updater 3a exceeds 1 s (Op34). When it does (“Yes” in Op34), the drive decision unit 2 instructs the status updater 3a to execute the status updating process P1. Accordingly, the status updating process P3, status updating process P2, and status updating process P1 are executed for every 5 ms, 100 ms, and 1 s, respectively.

When “Yes” is obtained in Op22, the status updater 3c executes the status updating process P3 for all the customers in the virtual space (Op23-Op27). In particular, the status updater 3c firstly selects the first customer (person) in the virtual space (Op23), and determines whether the status updating process P3 has been completed for all the customers (Op24). When it is determined that the status updating process P3 has been completed only for the first customer, it is judged that “No” is obtained in Op24. The status updater 3c obtains the data indicating the arrangement of products from the simulation data 8 (Op25). At the same time, the status updater 3c obtains the types of products in the area within a radius of 1 m around the position of the selected customer, and obtains the position, amount of space, and height in accordance with, for example, the reference range information 4c of FIG. 17. The status updater 3c updates the status data of the selected customer by using the obtained data (Op26). Here, by way of example, the amount of the movement of a customer is updated. Once the status data of the selected customer is updated, the next customer is selected (Op27). The processes of Op25-Op27 are repeated for all the customers in the virtual space (repeated until “Yes” is obtained in Op24). With the above, one sequence of the status updating process P3 is completed.

When the status updating process P3 terminates (when “Yes” is obtained in Op24), the drive decision unit 2 instructs the status updater 3b to execute the status updating process P2. The status updater 3b executes the status updating process P2 for all the customers in the virtual space (Op29-Op33). In particular, the status updater 3b firstly selects the first customer in the virtual space (Op29), and determines whether the status updating process P2 has been completed for all the customers (Op30). When it is determined that the status updating process P2 has been completed only for the first customer, it is judged that “No” is obtained in Op30. The status updater 3b obtains the data of the positions of other customers or the like from the simulation data 8 (Op31). At the same time, the status updater 3b obtains the positions of other customers in the area within a radius of 10 m around the current position of the selected customer, and the positions of shopping carts in accordance with, for example, the reference range information 4b of FIG. 17. The status updater 3b updates the status data of the selected customer by using the obtained data (Op32). Here, by way of example, the existence of obstacle avoidance for the selected customer is determined, and the traveling direction is updated. Once the status data of the selected customer is updated, the next customer is selected (Op33). The processes of Op31-Op33 are repeated for all the customers in the virtual space (repeated until “Yes” is obtained in Op30).

When the status updating process P2 terminates (when “Yes” is obtained in Op30), the drive decision unit 2 instructs the status updater 3a to execute the status updating process P1. The status updater 3a executes the status updating process P1 for all the customers in the virtual space (Op35-Op39). In particular, the status updater 3a firstly selects the first customer in the virtual space (Op35), and determines whether the status updating process P1 has been completed for all the customers (Op36). When it is determined that the status updating process P1 has been completed only for the first customer, it is judged that “No” is obtained in Op36. The status updater 3a obtains the data of the path link or the like from the simulation data 8 (Op37). At the same time, the status updater 3a obtains the path link of the path existing in the area within a radius of 100 m around the current position of the selected customer, and the data of bargain goods in accordance with, for example, the reference range information 4a of FIG. 17. The status updater 3a updates the status data of the selected customer by using the obtained data (Op38). Here, by way of example, the route of the selected customer is determined and updated according to the data of the path link and bargain goods. Once the status data of the selected customer is updated, the next customer is selected (Op39). The processes of Op37-Op39 are repeated for all the customers in the virtual space (repeated until “Yes” is obtained in Op36).

As described above, due to the processes of FIG. 20, it becomes possible to reduce the total amount of data referred to in the customer status updating process of a certain period of time, and to execute the customer status updating process at constant time intervals. For example, compared with the case in which all the simulation data (path link, product, shopping cart, position of other people, or the like) is read at constant time intervals for an individual customer and the customer status updating process is executed, it becomes possible to reduce the total amount of data referred to in the process. As a result, it is possible to prevent the amount of data referred to in the customer status updating process of each customer from increasing due to the increase in the number of customers or the increase in the target range. Consequently, it becomes easy to increase the scale.

### Third Embodiment

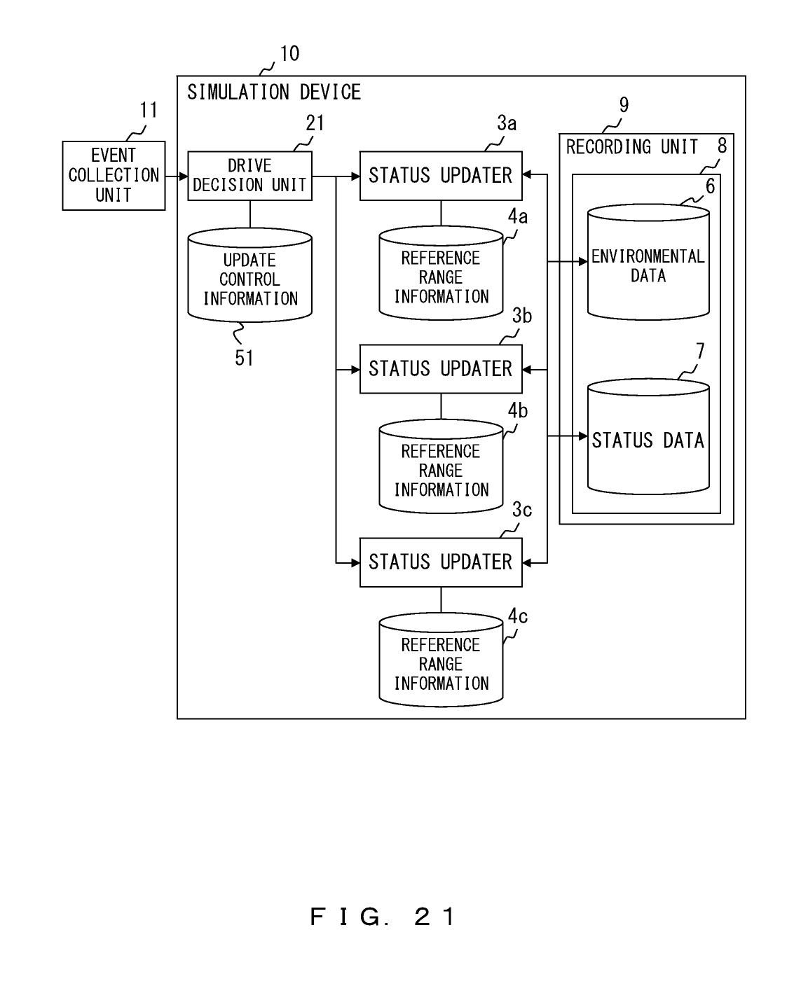

FIG. 21 is a functional block diagram illustrating the configuration of a simulation device according to the third embodiment. In FIG. 21, the same reference signs are given to the functional blocks which are the same as those of FIG. 1. In the simulation device 10 of FIG. 21, an event rule is recorded as the update control information 51. The event rule is an example of condition data, which indicates the condition for starting the status updating processes by the status updaters 3a-3c, and defines an event that functions as a condition for starting an updating process. Moreover, the simulation device 10 is configured to input outside circumstance data, which is collected by an event collection unit 11. In this configuration, the drive decision unit 21 detects an event caused in the simulation by using the event collection unit 11, and when the detected event satisfies the condition indicated by the event rule, the drive decision unit 21 instructs the status updaters 3a-3c to execute an update.

The event collection unit 11 collects events caused in the simulation, and notifies the drive decision unit 21 of the collected events. Such events include, for example, the status changes of a movable body expressed by the status data 7 or the changes in factors expressed by the environmental data 6. As specific examples of an event in the simulation of traffic flow according to the above-described first embodiment, arrival at a right-turn position or left-turn position, changes in traffic signals, the occurrence of traffic congestion, sudden changes in the weather, or the like are listed in each field. As described above, as a type of event, there are (a) events occurring due to conditions that are different for each vehicle. This type of even includes, for example, “vehicle arriving at a right-turn position or left-turn position” or “arriving at the destination”. As another type of event, there are (b) events occurring only for vehicles which are included in a certain range. This type of event includes, for example, “changes in a traffic signal”, “the occurrence of traffic congestion”, and “change in the weather”. Further, as another type of the event, the above-described [a] and [b] may be combined. This type of event includes, for example, “caught in traffic congestion, and running out of gasoline”.

For example, the status updaters 3a-3c may be configured to start the updating process with events having varying time intervals of average occurrence. Accordingly, the status updating process is divided into multiple hierarchies, and thereby it becomes possible to reduce the total amount of data referred to in the process.

The present embodiment may be combined with the first or second embodiment. For example, the update control information may include both the timing of status updating processes regularly executed at specified intervals and the timing of status updating processes executed when a specified event occurs. Accordingly, the status updating process may be divided into the hierarchies in which the process is executed at specified time intervals and the hierarchies in which the process is executed when a specified event occurs.

The above-described first to third embodiments are not limited to the real-time display of the simulation. For example, it is difficult to achieve real-time processing and display in a large scale simulation. It is possible that the results of a simulation may be accumulated in advance, and after performing a simulation, for the results of simulation to be displayed on a screen or the like according to the resultant data.

According to the disclosure of the Description of the present application, a simulation device, method, and program in which the total amount of data referred to in the status updating process can be cut down are provided.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A simulation device which simulates motion of at least one movable body, the simulation device being accessible to a recording unit which records simulation data which includes status data representing a respective status of the movable body and environmental data representing information on a possible factor in changing the status of the movable body, the simulation device comprising:
a plurality of status updaters to refer to the simulation data, and to execute a process of hierarchies into which a status updating process updating the status according to the referred to simulation data data is divided, the plurality of status updaters, in accordance with reference range information which is preliminarily recorded for each of the hierarchies and which indicates a reference range of the simulation data, referring to simulation data of the reference range and updating the status data of the movable body for each of the hierarchies; and
a drive decision unit to instruct the plurality of status updaters having the hierarchies to update the status data, the drive decision unit instructing the plurality of status updaters to update the status data according to update control information in which a timing of updating the status data is defined for each of the status updaters at a timing defined in the update control information.

2. The simulation device according to claim 1, wherein
the timing of an update indicated by the update control information is defined according to a range of the simulation data indicated by the reference range information.

3. The simulation device according to claim 1, wherein
the update control information includes a cycle in which the status updaters refer to the simulation data, and
the cycle in which the status updaters refer to the simulation data becomes longer as a range of the simulation data indicated by the reference range information becomes wider.

4. The simulation device according to claim 1, wherein
the status data is associated with the movable body, and the environmental data is recorded in association with the position information indicating the position at which a factor exists,
the range of the simulation data is indicated by an area with reference to the position at which the movable body exists, and
the status updaters refer to the status data of the movable body existing in the area and the environmental data of the factor existing in the area.

5. The simulation device according to claim 1, wherein
the timing of updating indicated by the update control information is defined by condition data which indicates a condition of starting an update, and
the drive decision unit detects an event caused in a simulation, and when the detected event satisfies a condition indicated in the condition data, instructs the status updater to execute an update.

6. The simulation device according to claim 1, wherein
the status updaters vary a range of the simulation data indicated by the reference range information depending on the timing of updating of each of the status updaters in the update control information and a velocity of the movable body.

7. The simulation device according to claim 1, wherein
the movable body is a vehicle moving within a space or on a plane, and
the plurality of status updaters includes at least
a first-hierarchy status updater to refer to the environmental data, which includes information of a path connection in a first area, including a position of the vehicle, and to update at least a route from a current position of the vehicle to a destination,
a second-hierarchy status updater to refer to the status data of other vehicles in a second area, including the position of the vehicle, and to update at least a lane in which the vehicle is traveling, and
a third-hierarchy status updater to refer to the status data of other vehicles in a third area, including the position of the vehicle, and to update at least velocity, a direction, and a position of the vehicle, and
the first area, the second area, and the third area have different sizes in a decremental order.

8. The simulation device according to claim 1, wherein
the movable body is a person moving in a space or on a plane, and
the plurality of status updaters includes at least
a first-hierarchy status updater to refer to the environmental data, which includes information of a path connection in a first area, and to update at least a route from a current position of the person to a destination,
a second-hierarchy status updater to refer to the status data of other people in a second area, and to update at least a direction in which the person is traveling, and
a third-hierarchy status updater to refer to the environmental data in a third area, including information of a presented item or equipment provided for a facility, and to update an amount of movement of the person, and
the first area, the second area, and the third area have different sizes in a decremental order.

9. A non-transitory computer readable medium storing simulation program executed by a computer to simulate motion of at least one movable body, the simulation program comprising:
a plurality of status updating processes to refer to simulation data which includes status data representing a respective status of the movable body and environmental data representing information on a possible factor in changing the status of the movable body, and to execute each process of hierarchies into which a status updating process updating the status data is divided according to the referred to simulation data, the plurality of status updating processes, in accordance with reference range information which is preliminarily recorded for each of the hierarchies and which indicates a reference range of the simulation data, referring to simulation data of the reference range and updating the status data of the movable body for each of the hierarchies; and
a drive decision process to control a timing of the plurality of status updating processes having the hierarchies, the drive decision process initiating an information updating process of the hierarchies according to update control information in which a timing of updating the status data is defined for each of the hierarchies at a timing defined in the update control information.

10. A simulation method in which a computer simulates motion of at least one movable body, the simulation method comprising:
a plurality of status updating steps in which the computer refers to simulation data which includes status data representing a respective status of the movable body and environmental data representing information on a possible factor in changing the status of the movable body, and executes each process of hierarchies into which a status updating process updating the status data is divided according to the referred to simulation data, the plurality of status updating steps, in accordance with reference range information which is preliminarily recorded for each of the hierarchies and which indicates a reference range of the simulation data, referring to simulation data of the reference range and updating the status data of the movable body for each of the hierarchies; and
a drive decision step in which the computer controls a timing of the plurality of status updating processes having the hierarchies, the drive decision step initiating an information updating process of the hierarchies according to update control information in which a timing of updating the status data is defined for each of the hierarchies at a timing defined in the update control information.
